(19) United States
(12) Patent Application Publication
(10) Pub. No.: US 2026/0336811 A1
(43) Pub. Date: Oct. 29, 2026

(54) GLAZING COMPRISING A FLOATING ANTI-STATIC LAYER

(71) Applicant: SAINT-GOBAIN SULLY, SULLY-SUR-LOIRE (FR)

(72) Inventors: Thomas TONDU, COURBEVOIE (FR); Jean Benoit MAYEUX, SULLY SUR LOIRE (FR)

(21) Appl. No.: 19/120,636

(22) PCT Filed: Oct. 3, 2023
(86) PCT No.: PCT/FR2023/051527

§ 371 Date: Apr. 11, 2025

(30) Foreign Application Priority Data
Oct. 14, 2022 (FR) FR2210572

(51) Int. Cl. B64D 15/12; B32B 17/10; B64C 1/14

(52) U.S. Cl. CPC B64D 15/12; B32B 17/10036; B32B 17/10165; B64C 1/1484; B32B 2307/21; B32B 2307/7376; B32B 2605/18

(57) ABSTRACT

A laminated glazing includes a first outer glass sheet having a thickness of between 0.5 and 5 mm and at least one structural glass sheet bonded in pairs by an adhesive interlayer, the laminated glazing being attached to a mounting structure by being clamped by a retainer bolted thereto and electrically integral with the mass thereof, the free surface of the first glass sheet supporting a floating anti-static layer having an electrical conductivity of less than 10 MOhm per square, and located at most 10 mm from the retainer, or more than 10 mm from the retainer, and the main surface of the first glass sheet internal to the structure of the laminated glazing supporting an electrode electrically integral with the mass of the mounting structure.

Aeronautical glazings are generally made of electrically insulating materials (glass, PMMA, PC, etc.) which tend to become electrically charged in certain environments through triboelectric effects. These environments are for example dust clouds from volcanic eruptions, snow and ice crystals. Typical currents that may be encountered are a few hundred μA/m² of glazing. For such currents, flows in the thickness and on the surface of the glazing can be neglected.

This creates a surface potential for the glazing that is different from that of the aircraft structure, which is generally fitted with passive dissipators.

Additionally, the aeronautical glazings are generally fitted with an anti-icing system covering all or part of the laminated surface of the glass (organic or mineral) exposed to load phenomena on its other face (outer sheet of glass, or outer glass).

Under charging conditions, this results in:
an intense electric field in the thickness of the outer glass (between its heating face and its charged face), which can lead to dielectric breakdown in its thickness and ruin;
significant electrical energy stored in the capacitor formed by the thickness of the outer glass (dielectric) and the two electrodes on its two surfaces. This energy can power tree-like surface discharges between the aircraft structure at the periphery of the glazing and the surface of the glazing. These discharges cause:
electromagnetic radiation which can disrupt the aircraft's electronics;
overvoltages or overcurrents, particularly on the temperature sensor circuits opposite the heating layer, used to regulate the glazing temperature to prevent icing;
dazzling of pilots by the glare of discharge light.

Establishing a surface discharge requires a sufficiently energetic plasma at the discharge tip. In practice, for a 3 mm thick glass at an atmospheric pressure of 1 bar, a surface potential of at least 25 kV is required for surface discharges to be established.

For all these reasons, it is sometimes necessary to provide an electrostatic discharge system which can:
consist of a surface treatment of the glass to give it dissipative (electrical) properties, connected to the aircraft's ground;
equip the outer surface of the glazing with metal tips connected to the aircraft's ground, enabling an early corona discharge. This second solution is not applicable to mineral glass, since in practice it is necessary to pierce the outer glass to run a wire to its surface. As a result, it is more often used on pierceable plastic glazings. The first solution can be applied to mineral glasses by applying a durable coating such as Indium Tin Oxide (ITO), Diamond-Like Carbon (DLC), or sub-stoichiometric oxide. Conductive layers can also be applied to organic lenses, but they are generally sensitive to scratching. For all these solutions, electrical charges are drained to aircraft ground via electrical wires.

Managing the routing of electrical wires to aircraft ground leads to complexities linked to issues of size, and/or visibility and/or interface and/or durability of the wire-dissipative layer connection. In particular, as the dissipative layers are on the surface of the glazings, they are subject to erosive environments. An electrical connection on this surface induces an extra thickness, increasing exposure to erosion and necessitating a flush-mounted protection strategy (aerodynamic disturbance, aerodynamic noise, erosion and associated maintenance). Lastly, the attachment of lightning to these drains, which are connected to the aircraft's internal mass, can lead to:
structural damage to the glazing;
electromagnetic radiation inside the aircraft structure;
heating and splashing of molten metal inside the aircraft, which can lead to fires.

The invention is based on the question of whether the above problems can be eradicated by leaving the anti-static layer floating, that is, not electrically connected to the ground of the mounting structure (in particular an aircraft cabin). The system must therefore be designed to promote discharges that do not degrade aircraft performance. These questions have been favorably answered by the invention which, as a result, relates to a laminated glazing comprising a first glass sheet and at least one structural glass sheet bonded in pairs by an adhesive interlayer, the free main surface of the first glass sheet being intended to be in contact with the outside atmosphere, the first glass sheet being set back with respect to said at least one structural glass sheet, and having a thickness of between 0.5 and 5 mm, the edge faces of the first glass sheet and of the first adhesive interlayer, and the free part of the main surface of the structural glass sheet, overhanging the first glass sheet, forming a cavity for receiving a retainer for attaching the laminated glazing by clamping to a mounting structure, with the mass of which the retainer is electrically integral, said free surface of the first glass sheet supporting an anti-static layer which is not electrically integral with the mass of the mounting structure, and which has an electrical conductivity of less than 10 MOhm per square, characterized in that at least one point of the anti-static layer is located at most 10 mm from the retainer, or the anti-static layer is integrally located at more than 10 mm from the retainer and the main surface of the first glass sheet internal to the structure of the laminated glazing supports an electrode electrically integral with the mass of the mounting structure.

When two flat electrodes face one another, when a threshold electric field (breakdown field) is reached, a discharge can start and almost instantaneously generate an arc. The discharge phase corresponds to the establishment of a sufficient electric field for an initial ionization (ionizing radiation, for example) to generate an avalanche of ionizations. Electrons are in fact accelerated by the effects of the electric field and can then generate further ionization by electron bombardment of the gas. Other mechanisms are also involved (excitation of molecular species, UV radiation, photoionization, electronic emission under ion and electron impact, electronic attachment, etc.).

The arc results from the creation of a conductive path in the air by heating the air as the current passes through it. In plane/tip or tip/tip configurations, the electric field is not homogeneous, and is more intense proximate to the tips. Only a volume proximate to the tips is capable of generating ionization avalanches. Discharge remains localized proximate to the tips. This is known as corona discharge or partial discharge. Despite its partial nature, this discharge is capable of flowing a current of about one mA/cm for linear geometries, that is, a high current compared with charging currents on aeronautical glazing, of about a few hundred μA/m² under highly charging conditions.

The electric field generated by charged elements can generate atmospheric plasmas. Ionized species (ions and electrons) are then transported by electric fields, and in particular charges can be carried to insulating surfaces such as glass. When partial discharges are initiated, the electric fields are modified by space charges in the air (separation of differently charged species and different species mobility) and on insulating surfaces. Since the mobility of surface charges is much lower than that of charges in the atmospheric phase, the latter have the greatest influence on potentials. Thus, for low-intensity discharges, the potentials of the insulators will settle so that no net current is collected.

For practical reasons, it is extremely complicated to ensure continuity between the anti-static layer and the retainer. A dielectric gap therefore exists on the glazing surface between the edge of the anti-static layer and the metal retainer. In a charging environment, different potentials are established between the retainer, the surface of the anti-static layer and the insulating dielectrics. The result is intense electric fields, notably due to the point effect at the edge of the metal structure and at the edge of the (very thin) anti-static layer. As a result, partial discharges are triggered, generating a plasma that charges the dielectric surface.

Under steady-state conditions, the dielectric surface is at an intermediate potential between a metallic structure and an anti-static layer. Point effects are then shielded by space charges on dielectrics. This results in the extinction of partial discharges. In the air gap between the retainer and the anti-static layer, potential lines can be achieved that are relatively parallel to one another and perpendicular to the glazing surface, which are characteristic of plane-to-plane discharges, and the discharge criteria are therefore governed by Paschen's law. These discharges have an immediate arc transition. Since the arc currents are very high, the charges in the anti-static layer cannot feed the arc by conduction in the latter, but only by movement of the arc head on the surface of the anti-static layer. This is the surface discharge mechanism already described. To avoid these discharges, it is necessary to ensure that the potential of the glass is below the potential required to establish surface discharges (typically 25 kV for 3 mm glass). The breakdown fields described by Paschen's law are 30 kV/cm at atmospheric pressure (worst case). To allow partial discharges, the edge of the layer must be less than 8 mm from the retainer at least at one point.

Thus, according to the first alternative of the invention, the floating anti-static layer with an electrical conductivity of less than 10 MOhm per square positioned on a 0.5 to 5 mm glass is located at least at one point less than 10 mm from an element electrically integral with the aircraft ground.

In accordance with the second alternative of the invention, an electric field singularity is generated in the vicinity of the floating anti-static layer edge by means of an electrode integral with the aircraft ground present in the laminate, ideally on the inner surface of the outer glass. In this second alternative or configuration, the electric field is influenced more by the potential of the laminate electrode than by the retainer.

Here too, discharge initiation causes charges to be deposited on the glass surface in such a way that the electric field on the glass surface is parallel thereto in the active zone of the discharge. In this case, the influence of the ground electrode creates a point effect at the edge of the layer.

If the edge of the anti-static layer is sufficiently far from the edge of the retainer, a corona discharge can be generated which does not attach to the glazing retainer, thus preventing any degradation of the latter.

Such a configuration is known as a dielectric barrier discharge and can typically initiate partial discharges for 3 mm of glass from a potential difference between the anti-static layer and the ground electrode of 6 kV for 3 mm thick glass. This is therefore a gentler discharge mode than that of the first alternative of the invention.

According to the invention, a glass sheet refers both to a sheet of mineral glass of the soda-lime, aluminosilicate, borosilicate or float glass type, optionally thermally toughened or chemically strengthened, and to a sheet of transparent polymer material such as poly(methyl methacrylate) (PMMA), polycarbonate (PC), poly(ethylene terephthalate) (PET), polyurethane (PU), etc. The first glass sheet is a relatively thin surfacing sheet, in contrast to the structural sheet(s), which are sheets capable of guaranteeing the mechanical properties required for the laminated glazing, particularly where the latter is to delimit a pressurized volume such as an aircraft. When the structural block comprises only one sheet of glass, this is considered to be structural provided that its elastic modulus is at least equal to 1500 MPa, for example. The structural glass sheet(s) is (are) made, for example, of mineral glass with a thickness of between 1.6 and 10 mm, or of PMMA-type polymer material with a thickness of between 3 and 30, preferably at most 20 mm.

An adhesive interlayer consists of a thermoplastic polymer, mainly polyvinyl butyral (PVB), thermoplastic polyurethane (TPU), ethylene-vinyl acetate copolymer (EVA), casting resin or ionomer resin. The thickness of the first adhesive interlayer bonding the first glass sheet to the first structural sheet is between 3 and 10, preferably 4 and 8 mm, while the thickness of the subsequent adhesive interlayer(s) bonding structural sheets in pairs is between 0.5 and 4 mm, preferably at most 2 mm.

Preferably, the anti-static layer is made of a doped oxide such as indium tin oxide (ITO) or aluminum zinc oxide (AZO), a non-stoichiometric oxide such as SnO₂, or Diamond-Like Carbon (DLC), with a thickness of between 5 nm and 1 um, preferably between 10 and 50 nm. The anti-static layer can be deposited on the glass by PVD (Physical Vapor Deposition) means, such as magnetic field-magnetron assisted sputtering under reduced pressure, or by liquid means, such as sol-gel.

Preferably, the anti-static layer has an electrical conductivity of at least 100 Ohm per square, preferably 10 kOhm per square, and at most 100 kOhm per square.

Preferably, the electrode is closer to the retainer than the anti-static layer, preferably by a distance at least equal to the thickness of the first glass sheet, the electrode edge distal to the retainer is closer to the latter than the proximal edge of the anti-static layer by a distance at most equal to the thickness of the first glass sheet, further away by a distance at most equal to the characteristic dimensions of the main surfaces of the first glass sheet, and the length of the electrode in the direction normal to the retainer is at least equal to the thickness of the first glass sheet.

Preferably, the edge of the anti-static layer proximal to the retainer is straight and parallel to the retainer, or has point effects to promote the initiation of electrical discharges.

In the latter case, the proximal edge of the anti-static layer with respect to the retainer comprises tips preferably in the form of triangles, rectangles longer than they are wide, rectangles with rounded corners or rectangles terminated by triangles, the sides of the rectangles or triangles being straight or curved so as to form concave or convex edges, and the tips being integrally opposite the electrode if there is one. The tips can be obtained by selective ablation of the anti-static layer, for example by laser, mechanical or chemical methods. They can be obtained by masking at the deposition stage.

Preferably, the electrode forms the anti-icing heating layer or is an additional electrode such as indium tin oxide (ITO) or equivalent. If the laminated electrode is the heating layer itself, it is ensured that in non-heating phases it remains at the potential of the mounting structure.

The invention also relates to the use of the laminated glazing described above as aircraft cockpit glazing, in particular windscreens, especially for medium-and long-haul commercial aircraft, business aircraft and tourist aircraft.

The invention will be better understood in view of the following description of the appended drawings, wherein:

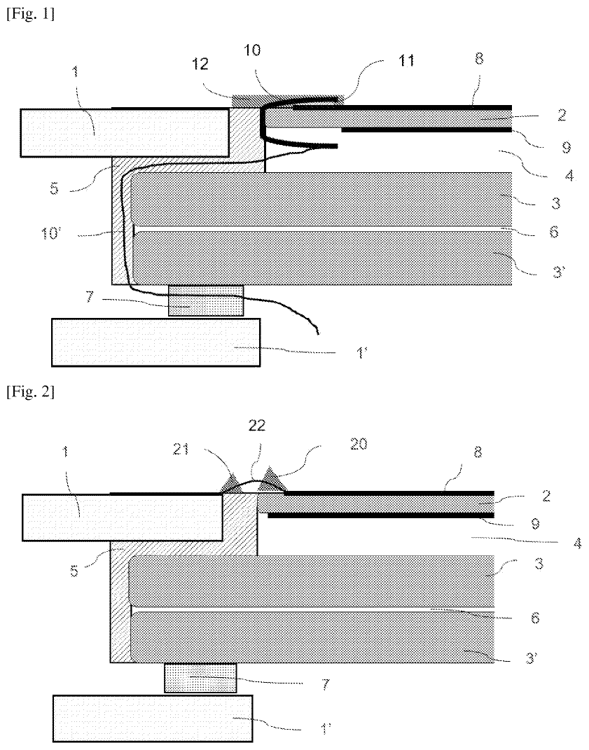

FIG. 1 is a schematic cross-sectional view of a glazing in the state of the art;

FIG. 2 is a schematic cross-sectional view of a glazing according to the first alternative of the invention;

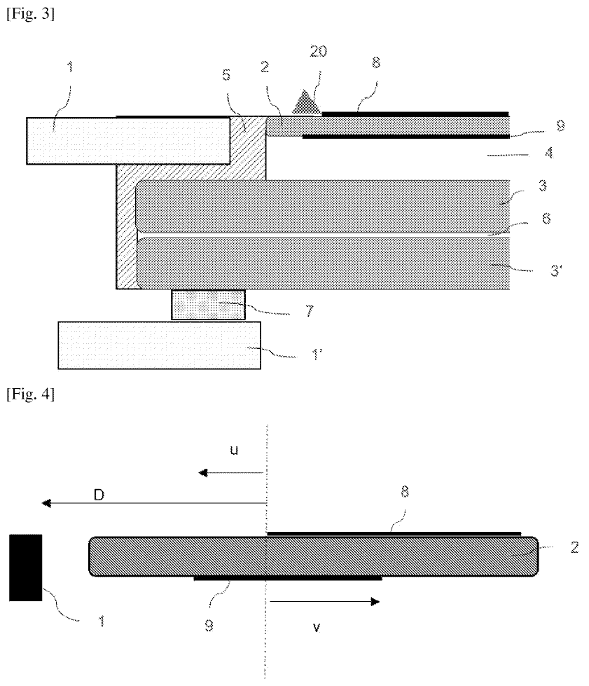

FIG. 3 is a schematic cross-sectional view of a glazing according to the second alternative of the invention;

FIG. 4 is a partial schematic depiction of a glazing according to the second alternative of the invention;

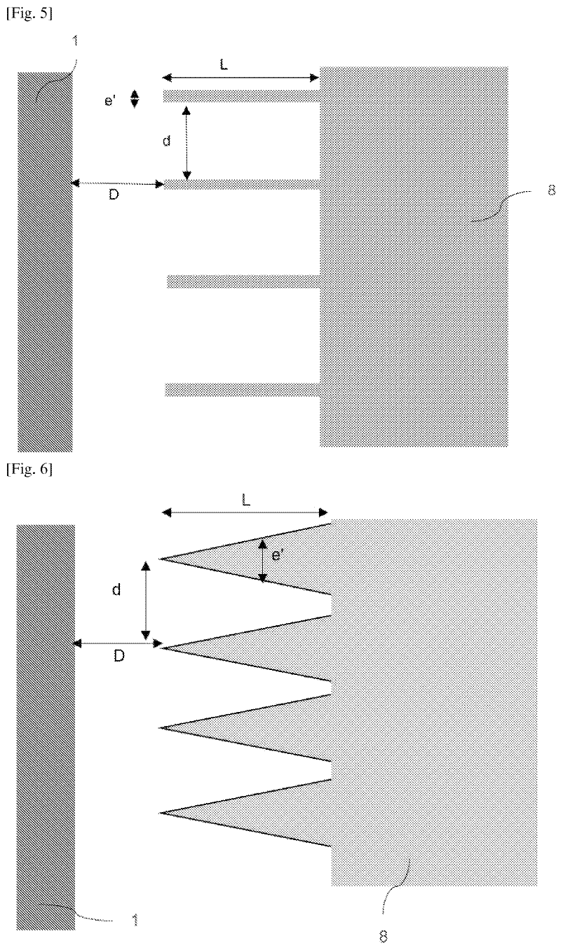

FIG. 5 and FIG. 6 are two schematic front views of the exterior of glazings conforming to the invention.

With reference to FIG. 1, a commercial aircraft windscreen representative of the state of the art consists of a thin outer glass sheet 2 bonded to a relatively thick structural glass sheet 3 via a relatively thick layer 4 of TPU. The glass sheet 3 forms the structural block of the laminate with the relatively thick structural glass sheet 3′, to which it is bonded by a relatively thin layer 6 of PVB. The laminated glazing rests on an inner retainer 1′, which may be the aircraft structure, with the interposition of a shim 7. The glazing is attached to the mounting structure by the retainer 1, an external retainer consisting of an window pane retainer which, when bolted to the aircraft structure, exerts pressure on the edge of the structural block 3, 6, 3′ via the silicone seal 5.

An electrical connection is established between the anti-static layer 8 and the aircraft ground (not shown). This connection can be achieved by bonding a first conductive connection element 10 and a lead wire 10′ to an aircraft ground connection, using a conductive adhesive 11. Depending on the case, 10 and 10′ may be a single wire or, preferentially, a thin metal foil-type element for 10 and a wire 10′, for example, brazed together. Such an assembly requires protection 12 against erosion and moisture penetration. The inner face of the laminated structure of the first glass sheet 2 or outer glass sheet supports an ITO anti-icing heating layer 9, connected to the ground of the aircraft structure via electrical sources. This configuration has the disadvantages described above.

FIG. 2 describes the first alternative of the invention. Here, the anti-static layer 8 is floating, or in other words, not electrically connected to the ground of the aircraft structure. The anti-static layer 8 is at most 10 mm from the retainer 1 (or window pane retainer). Shown are a corona discharge 20 at the edge of the anti-static layer 8, a corona discharge 21 at the edge of the retainer 1, and an arc 22 between the anti-static layer 8 and the retainer 1. The transition from corona discharges 20 and 21 to the arc discharge 22 may exceptionally occur, but in an unstable manner and without causing surface discharges.

FIG. 3 describes the second alternative of the invention, according to which the anti-static layer 8 is entirely located more than 10 mm from the retainer 1 and the heating layer or electrode 9 is electrically integral with the mass of the mounting structure, so that electrical discharges preferentially occur at the edge of the anti-static layer owing to the electric field amplification generated by the proximity of the electrode 9. The electrical charges are then released into the air, where they can be totally or partially recollected by the aircraft, but without any discharge phenomenon. The corona discharge 21 and the electric arc 22 of FIG. 2 no longer occur, while the corona discharge 20 is maintained.

With reference to FIG. 4, the relative positions of the anti-static layer 8, the laminated electrode 9 and the retainer 1 are shown, according to the second alternative of the invention. These relative positions can be defined by the fact that
u is positive, preferentially greater than a thickness e of the outer glass 2;
v is between −e and any positive value less than the characteristic size of the outer glass 2 (length L and width I of its main surfaces);
u+v>e; and
D>10 mm.

The edge of the anti-static layer 8 can be generally straight or textured to form tips or fingers facing the retainer 1 (first alternative of the invention), and/or integrally facing the laminated electrode (second alternative of the invention). Figures [symbol] Error! Reference source not found. and Error! Reference source not found. show the retainer 1 and two configurations of anti-static layer 8 with a pointed edge, representative of both the first alternative of the invention (D≤10 mm), and the second (D>10 mm). Typical choices are e′ less than or equal to the thickness of the outer glass 2, d greater than or equal to the thickness of the outer glass 2, and L greater than the thickness of the outer glass 2. The discharge zone consists of a layer of the same type as the anti-static layer 8, the edges of which are formed by masking during deposition, ablation after deposition, e.g. by laser, or additional deposition of conductive elements, e.g. by bonding or screen printing.

The proposed solution is to be compared with a glazing not fitted with an anti-static solution, on the one hand, and a glazing fitted with an anti-static layer discharged by a drain, on the other hand. Compared with solutions without an anti-static layer, the solution of the invention eliminates dazzling and radiating discharges (electromagnetic, visual and sound disturbances).

The use of a conductive drain between the outer surface of a glazing and the inner structure of the aircraft has the following limitations:
complexity of implementing a reliable electrical connection between a non-metallic layer and a metallic drain (bonding, differential expansion, sensitivity to humidity, etc.);
protrusion (aerodynamic impact, including noise);
risk of glass breakage or internal fire in the event of lightning striking the drain.

These limitations are solved by the present invention.

1. An assembly or module comprising a laminated glazing comprising a first glass sheet and at least one structural glass sheet bonded in pairs by an adhesive interlayer a free main surface of the first glass sheet being intended to be in contact with an outside atmosphere, the first glass sheet being set back with respect to said at least one structural glass sheet, and having a thickness of between 0.5 and 5 mm, the assembly or module comprising a retainer for attaching the laminated glazing by clamping to a mounting structure with a mass of which the retainer is capable of being electrically integral in a mounting position of the laminated glazing, edge faces of the first glass sheet and of the adhesive interlayer, and the a free part of the a main surface of the structural glass sheet, overhanging the first glass sheet forming a cavity for receiving the retainer, said free main surface of the first glass sheet supporting an anti-static layer with an electrical conductivity of less than 10 MOhm per square, wherein, in the mounting position of the laminated glazing, the anti-static layer is configured so as to be non-electrically integral with the retainer on the one hand, with the mass of the mounting structure on the other hand, at least one point of the anti-static layer is located at a non-zero distance of no more than 10 mm from the retainer or the anti-static layer is integrally located more than 10 mm from the retainer and the main surface of the first glass sheet internal to the laminated glazing structure supports an electrode configured to be electrically integral with the mass of the mounting structure.

2. The assembly or module according to claim 1, wherein the anti-static layer is made of a doped, a non-stoichiometric oxide, or Diamond-Like Carbon (DLC), with a thickness of between 5 nm and 1 μm.

3. The assembly or module according to claim 1, wherein the anti-static layer has an electrical conductivity of at least 100 Ohm per square and at most 100 kOhm per square.

4. The assembly or module according to claim 1, wherein in the mounting position of the laminated glazing, the electrode is closer to the retainer than the anti-static layer, an edge of the electrode distal from the retainer is closer to the retainer than a proximal edge of the anti-static layer by a distance at most equal to a thickness of the first glass sheet, at most by a distance equal to the characteristic dimensions of the main surfaces of the first glass sheet, and the a length of the electrode in a direction normal to the retainer is at least equal to the thickness of the first glass sheet

5. The assembly or module according to claim 1, wherein in the mounting position of the laminated glazing, an edge of the anti-static layer proximal to the retainer is straight and parallel to the retainer, or has point effects to promote initiation of electrical discharges.

6. The assembly or module according to claim 1, wherein in the mounting position of the laminated glazing, an edge of the anti-static layer proximal to the retainer comprises tips in the form of triangles, rectangles longer than they are wide, rectangles with rounded corners or rectangles terminated by triangles, sides of the rectangles or triangles being straight or curved so as to form concave or convex edges, and the tips being integrally opposite the electrode if there is one.

7. The assembly or module according to claim 1, wherein the electrode forms the anti-icing heating layer or is an additional electrode.

8. A method comprising providing an assembly or module according to claim 1 as aircraft cockpit glazing.

9. The assembly or module according to claim 2, wherein the doped oxide is indium tin oxide (ITO) or aluminum zinc oxide (AZO), of wherein the non-stoichiometric oxide is SnO2.

10. The assembly or module according to claim 2, wherein the thickness of is between 10 and 50 nm.

11. The assembly or module according to claim 3, wherein the anti-static layer has an electrical conductivity of at least 0 kOhm per square and at most 100 kOhm per square.

12. The assembly or module according to claim 1, wherein, in the mounting position of the laminated glazing, the electrode is closer to the retainer than the anti-static layer by a distance at least equal to the thickness of the first glass sheet.

13. The assembly or module according to claim 1, wherein the electrode is made of indium tin oxide (ITO).

14. The method according to claim 8, wherein as aircraft cockpit glazing is a windscreen.

15. The method according to claim 8, wherein the aircraft is a medium or long-haul commercial aircraft, or a business aircraft or a tourist aircraft.
